(19) United States
(12) Patent Application Publication
(10) Pub. No.: US 2011/0071850 A1
(43) Pub. Date: Mar. 24, 2011

(54) METHOD AND SYSTEM FOR MANAGING HEALTHCARE RESOURCES

(75) Inventor: Sridhar Nuthi, Pewaukee, WI (US)

(73) Assignee: GENERAL ELECTRIC COMPANY, Schenectady, NY (US)

(21) Appl. No.: 12/565,122

(22) Filed: Sep. 23, 2009

(51) Int. Cl. G06Q 50/00

(52) U.S. Cl. 705/3

(57) ABSTRACT

A method and system for managing patients and healthcare resources in a healthcare environment is disclosed herein. The method comprises: identifying patient location in a healthcare environment and accessing patient information including demographic information and patient's current medical condition. A healthcare resource is identified using the patient information, patient location and resource availability. The method further comprises: providing at least one customized resource setting parameter derived based on patient information, along with the patient information to the identified healthcare resource and assigning the patient to the identified healthcare resource. The healthcare resource is configured using the resource setting parameter, upon detecting the patient in proximity of the healthcare resource.

### FIELD OF INVENTION

This invention relates generally to a method and system of managing patients and healthcare resources in a healthcare environment and more particularly to, a method and system for scheduling a patient based on the resource availability and customizing or providing the patient information to the healthcare resource in advance.

### BACKGROUND OF INVENTION

Manual patient Admit Discharge Transfer (ADT) process in a healthcare environment is error prone and time consuming. Every time the clinicians have to interact with the patient monitors or the patient manually to gather patient information. Before examining a patient, the clinician needs to know some information such as patient's demographic information. Many times the demographic information is passed to the clinicians through patient monitoring devices using existing gateway solutions. However, the existing workflow requires manual intervention from clinician to obtain the patient information.

Some of the problems associated with the manual ADT process include accessing or obtaining wrong patient information, accidental discharges, inefficient transfers etc.

Another potential problem associated with the existing technique is the possibility of inconsistency between hospital information systems data and monitoring device data. This could happen because wrong data has been accessed to the monitoring device or the hospital information systems are not updated with the latest patient information.

Yet another issue with the manual patient management within a healthcare environment is the inefficiency in the clinical workflow. Currently, resource utilizations and capabilities information are directly synchronized to the registration application. Any change in the workflow at a later stage will not be taken care automatically.

Manually scheduling patients in a healthcare environment is time consuming and could result in various errors. Further, once the patient reaches the clinician, the clinician needs to access the patient information such as his demographic information or previous history. The patient information is accessed from a server or a database and this takes time in downloading the information and displaying it to the clinician. Also, the patient monitors or any other healthcare resource needs to be customized for a patient. Currently, the customization of the monitoring device or configuring the monitoring device for a patient is done after the patient reaches the monitoring device. The customization takes time and patient has to wait and this affects the productivity of the monitoring devices and the clinicians.

Also, in a healthcare environment, it is common that the patients are scheduled based on an identified problem and later, the caretaker may realize that the patient need to be taken to a different department or to a different clinician. For example, on the way to a clinician, the patient's condition may become serious and he may need to be taken to the ICU. Currently, similar situations are handled manually and could result in various errors, as the workflow is not updated automatically. This change in course of action needs to be communicated to clinician, earlier scheduled location, proposed new location etc. Currently if there is any change in the existing workflow or ADT process, handling these changes are not done automatically and hence the healthcare resources and the patients are not coordinated effectively. Further currently, existing healthcare management system includes multiple subsystems to support one function and lots of human intervention is required to coordinate among these multiple systems.

Thus there exist a need for an improved method and system for managing patients and healthcare resources in a healthcare environment.

### SUMMARY OF INVENTION

The above-mentioned shortcomings, disadvantages and problems are addressed herein which will be understood by reading and understanding the following specification.

One embodiment of the present invention provides a computer aided method for managing patients and healthcare resources in a healthcare environment. The method comprises: identifying patient location in a healthcare environment; accessing patient information including demographic information and patient's current medical condition; identifying a healthcare resource using the patient information, patient location and resource availability; providing at least one customized resource setting parameter derived based on patient information, along with the patient information to the identified healthcare resource; assigning the patient to the identified healthcare resource; and configuring the healthcare resource using the resource setting parameter, upon detecting the patient in proximity of the healthcare resource.

In another embodiment, a computer aided method for managing patients and healthcare resources in a healthcare environment is disclosed. The method comprises: identifying a change in a patient's medical condition; communicating the change to a server along with the patient's location information; accessing patient information from a database through the server; identifying a healthcare resource based on the updated medical condition, patient information and patient location; re-scheduling the patient for the identified healthcare resource; and communicating resource information to the patient and the patient information to the healthcare resource.

In another embodiment, a system for managing patients and healthcare resources in a healthcare environment is disclosed. The system comprises: a data repository for storing patient information including demographic information and patient's current medical condition and healthcare resource information in the healthcare environment; plurality of tracking devices for identifying patient location and healthcare resource location in a healthcare environment and communicating location information to the data repository; a data access program module configured to access patient information and the healthcare resource information from the data repository; and a processor operatively connected to the data access program module to identify and configure a healthcare resource based on the patient information and patient location and resource availability.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram of a patient and healthcare resources management system as described in an embodiment of the invention;

FIG. 2 illustrates an automated Admission Discharge Transfer (ADT) system as described in an embodiment of the invention;

FIG. 3 illustrates an automated Admission discharge Transfer (ADT) process as described in an embodiment of the invention;

FIG. 4 is a flowchart illustrating a patient and healthcare resource management method as described in an embodiment of the invention;

FIG. 5A and FIG. 5B show a detailed flowchart illustrating a patient and healthcare resource management method as described in an embodiment of the invention; and

FIG. 6 is a flowchart illustrating a method of re-scheduling patients in a healthcare environment as described in an embodiment of the invention;

### DETAILED DESCRIPTION OF INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

Embodiments of the present invention provide a method and system for managing patients and healthcare resources in a healthcare environment. The method further discloses assigning a patient to a healthcare resource and configuring the healthcare resource based on the patient's need and medical condition, even before the patient reaches the resource.

The term “information” referred to in the specification need not refer to one parameter, but includes a list of parameters unless otherwise specified. Similarly the terms “demographic information”, “healthcare resource information” and “patient information” need not be limited to the examples mentioned in the specification. Rather, the term “healthcare resource information” could include any hospital or clinician or clinical equipment relevant information and the term “patient information” could include any information related to a patient. The examples and techniques described are applicable to whole healthcare domain including Home care solutions. Further invention need not be limited to healthcare domain, it could be used in various other applications such as asset tracking.

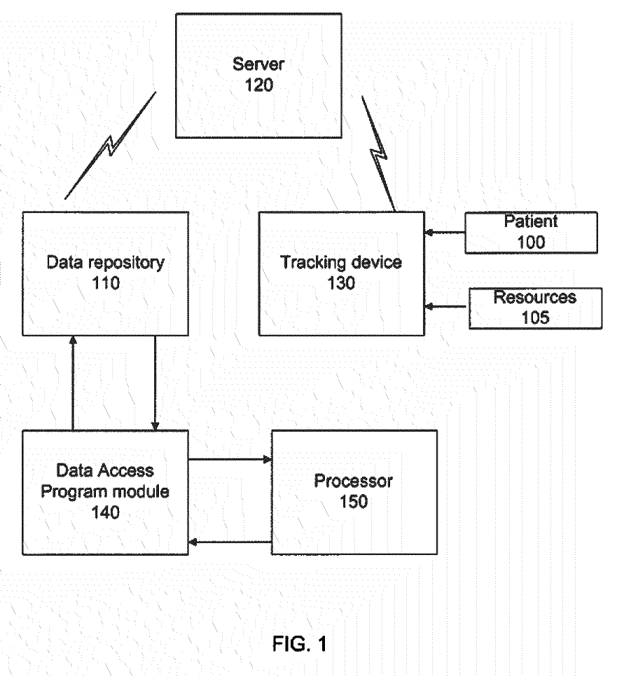

FIG. 1 is a block diagram of management system configured to manage patients and healthcare resources in a healthcare environment as described in an embodiment of the invention. The medical information management system comprises: a data repository 110 for storing patient information. In an embodiment, various patient information could be accessed from the data repository 110 on a need basis through a server 120. In an embodiment, the data repository 110 may be located internally or external to the healthcare environment. The patient information could include patient demographic information such as name, patient identification number, age, sex, race, height, weight, physician identification number etc, but need not be limited to these examples. In an embodiment, the patient information is updated at the data repository 110. Further, data repository 110 could be updated with the current medical condition of the patient and patient location.

In an embodiment, a plurality of tracking devices 130 are provided with the patient 100, healthcare resources 105 such as clinician, caretaker, technician, patient monitoring devices, diagnostic equipments, different clinical labs, departments etc. For some resources, locations are permanent and for some, the location information changes dynamically. Healthcare resource could include any clinical equipment, hospital staff or other facilities in a healthcare environment. All these information is tracked by the tracking devices 130 and send it to the data repository 110 directly or to the data repository 110 through the server 120. Tracking devices 130 include RFID, Bluetooth devices, smart chips etc and could communicate wirelessly to the server 120.

In an embodiment, the patient's current medical condition is also updated in the data repository 110. The patient 100 may arrive at the healthcare environment, with a certain problem and he may be scheduled based on the identified problem. But the condition of the patient may change and he may need to be shifted to another location for another treatment than the scheduled one. This information may be communicated to the data repository 110. Thus the data repository 110 has the information about the patient's current location, current medical condition etc.

Apart from this, the data repository 110 includes information about the healthcare resource, their schedule, availability etc. The healthcare resource schedule includes clinician schedule as well as the schedule of the patient monitoring or diagnostic equipments.

A data access program module 140 is configured to access the patient information and healthcare resource information from the data repository 110. The data access program module 140 feeds this information to a processor 150. The processor 150 processes the healthcare resource information and the patient information to identify an available healthcare resource and schedules it for the patient. While scheduling, the processor 150 may consider, the patient location, current medical condition such as severity etc and the resource availability. Once the scheduling is done, the schedule is communicated to the data repository 110, healthcare resource 105 and to the patient 100.

The patient 100/healthcare resource 105 is provided with tracking device 130 and the tracking device 130 communicates the patient location/resource location to the data repository 110. The data repository 110 through data access program module 140 communicates the same to the healthcare resource 105/patient 100.

In an embodiment, on standby mode of the healthcare resource 105, the patient information, including his demographic information is passed to the identified healthcare resource 105 such as patient monitoring device. Once the patient 100 is in close proximity of the identified healthcare resource 105, the patient information could be displayed on the healthcare resource.

In an embodiment, upon the patient reaching close proximity to the healthcare resource 105, the healthcare resource 105 may be configured based on a customized resource setting parameter. The customized resource setting parameter is derived from the patient information or his medical condition and could be sent to the resource at standby mode.

In an embodiment, a processor 150 is configured to auto synchronize patient information between the healthcare resource 105 and the patient 100. The processor 150 could be located with the healthcare resource or could act as a standalone device configured to manage patients and resources. The processor 150 could be software or hardware implemented. Dedicated hardware may be used instead of software and/or firmware for performing information processing, or a combination of dedicated hardware and software, or software in combination with a general purpose processor or a digital signal processor may be used. Once the requirements for such software and/or hardware and/or dedicated hardware are gained from an understanding of the descriptions of embodiments of the invention contained herein, the choice of any particular implementation may be left to a hardware engineer and/or software engineer. However, any dedicated and/or special purpose hardware or special purpose processor is considered subsumed in the block labeled processor 150. Different parts of the management system may be combined to a single unit or module and implemented.

In an embodiment, the system is configured to reschedule a pre-scheduled patient 100 upon detecting some changes in the patient's medical condition.

In an embodiment, the data repository 110 is an EMR (Electronic Medical Record) or EHR (Electronic Heath Record). Various other embodiments, data repository could include memory devices such as random access memory (RAM), flash memory, or read-only memory. For purposes of simplicity, devices that can read and/or write media on which computer programs are recorded are also included within the scope of the term “memory.”

In some embodiment, the management system could comprise software or firmware instructing a computer to perform certain actions. Some embodiments of the present invention comprise stand-alone workstation computers that include memory, a display, and a processor. The workstation may also include a user input interface include a mouse, a touch screen and stylus, a keyboard with cursor keys, or combinations thereof.

In an embodiment, the invention provides a method and system for automated admission discharge transfer (ADT) process. ADT is sent to the resource in its standby mode and is activated based on the proximity of the patient to the healthcare resource.

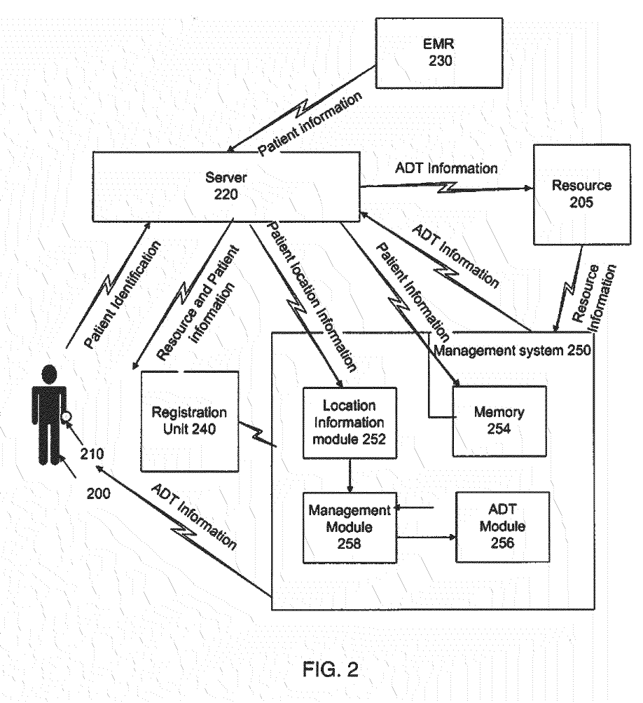

FIG. 2 illustrates an automated Admission Discharge Transfer (ADT) system as described in an embodiment of the invention. The patient 200 is provided with a tracking device 210 and the entry of the patient into a healthcare environment is detected and is communicated to a server 220. The healthcare environment should also have different resources 205 such as medical equipment, clinicians etc. In an embodiment, patient 200 could be provided with an RFID (Radio Frequency Identifier) and the patient's identification number could be communicated to the server 220. Once the patient 200 is identified by the server 220 or the server 220 receives the patient identification number, the server 220 accesses an EMR 230 and receives the patient information including demographic information and previous medical history, if any. The server 220 could pass this information automatically to a registration unit 240 that helps patient 200 in scheduling an appointment.

In an embodiment, the server 220 passes patient information and location information to a management system 250. The management system 250 is configured to manage or schedule the patient 200, based on certain rules such as patient location, current medical condition, resource availability etc. In an embodiment, the management system 250 has a location information module 252 configured to receive location of patient from the tracking devices 210 through server 220. Apart from the patient location, the location information module 252 could have information about various healthcare resources location. The location information module 252 is updated based on change in location of the patient or any other healthcare resource.

The management system 250 further includes a memory 254 configured to store the information received from the server 220. This could include patient information accessed from the EMR 230 or the location information accessed from the location information module 252. The memory 254 should also have resource information such as resource availability, location etc. This could be accessed directly from the resource 205 or through a server 220 from an external device that stores the resource information.

The management system 250 includes a management module 258 configured to receive the patient information, location information and the resource information and identify an available healthcare resource 205 and schedule the patient 200. An ADT is defined for a patient by the management module 258 and stored in an ADT module 256. The management module 258 is configured to derive some customized resource setting parameter for the healthcare resource 205 based on the patient information.

Once the resource 205 is scheduled, the patient information is sent to the resource 205 by the management system 250 through the server 220. The management system 250 also communicates the resource information such as its location to the patient.

In an embodiment, the ADT is communicated to the healthcare resource in its standby mode. ADT could be communicated to the patient as well. Alternately, this information may be sent to the registration unit 240 and the registration unit 240 could inform the patient and for the scheduled resource. Optionally the patient information, resource information etc could be sent to the registration unit 240 and the registration unit might identify the available resource and pass the information to the patient or to the resource.

In another embodiment, the management system 250 is configured to receive changes in patient location or his medical condition through the server 210. According to these changes, the ADT may need to be updated. The management module 258 identifies different resources or sets a different time based on the changes. The changed ADT is communicated to the newly scheduled and/or to earlier scheduled healthcare resource. Along with the ADT information, patient information such as his demographic information could also be communicated to the healthcare resource.

The scheduling information could be sent to the patient directly or through the registration unit 240.

The healthcare resource 205 receives the patient proximity information and upon detecting the patient 200 near to the healthcare resource 205 the ADT information is displayed on the resource 205. The ADT is provided to the resource 205 while the resource 205 is in standby mode and when the patient 200 approaches the resource 205, ADT is available with the resource 205. Any change in the patient's medical condition may change the ADT and the ADT module 256 will be updated with the latest ADT information and will be communicated to the resource 205 accordingly.

In an embodiment, portions of the software may have specific functions, and these portions are herein referred to as “modules” or “software modules.” However, in some embodiments, these modules may comprise one or more electronic hardware components or special-purpose hardware components that may be configured to perform the same purpose as the software module or to aid in the performance of the software module. Thus, a “module” may also refer to hardware or a combination of hardware and software performing a function.

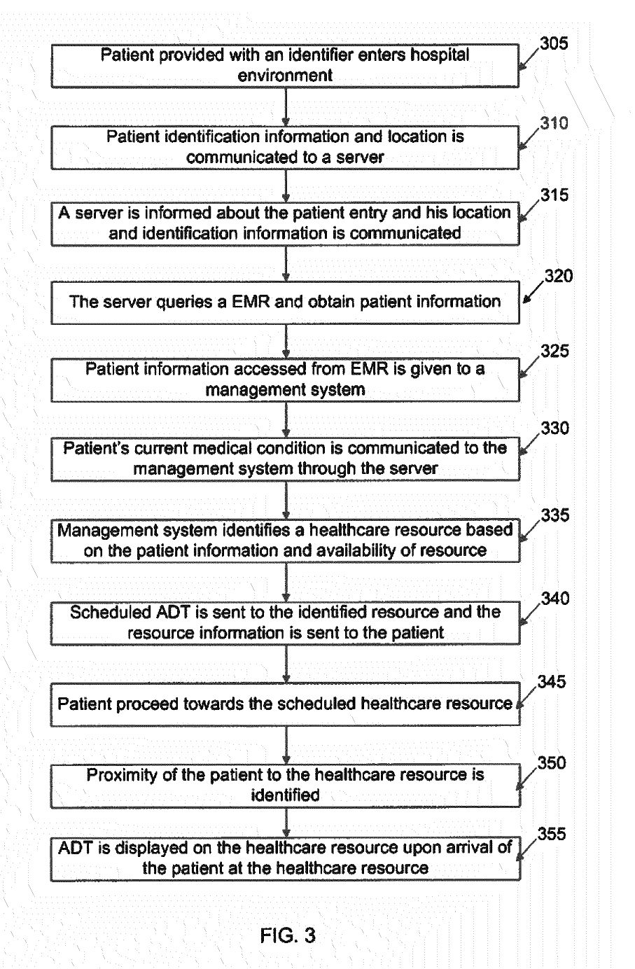

FIG. 3 illustrates an Automated Admission discharge Transfer (ADT) process as described in an embodiment of the invention. At step 305, a patient enters into the healthcare environment. Patient is provided with an identifier such as RFID, smart card or Bluetooth devices. The identifiers can be tracked and through the identifiers the presence of the patient is detected and his current location is tracked. The patient identification information along with the current location is sent to a server as at step 310. Thus the server identifies the presence of the patient within the healthcare environment, as soon as he enters into the healthcare environment. The server communicates with a management system that manages workflows in a healthcare environment. At step 315, the server updates the information on the patient such as patient identification number, current location etc to the management system and the management system may update any workflow associated with the patient. At step 320, the server accesses an EMR or any other data storage to access patient information including his demographic information and the previous history. At step 325, the server provides the patient information to the management system or to a registration unit, which assist with patient and resource management. Current patient medical condition is sent to the management system through the server by the registration unit or by any other means, as shown at step 330. At step 335, based on the patient information and availability of the resources, the patient and the resources are scheduled or a suitable resource is identified. At step 340, an ADT (Admit discharge transfer) is sent to the resource while the resource is at standby mode. The resource information is passed to the patient along with the navigation information such location of the resource, scheduled time etc to the patient. The resource is provided with the patient information such as his demographic information. At step 345, the patient approaches the scheduled resource and the patient's proximity to the scheduled device is tracked at step 350. Upon detecting the patient in proximity of the resource, the ADT is displayed on the resource, as at step 355. The ADT provided to the resource, may be displayed after validation. If there is any change in the patient's medical condition or the location, ADT is updated and sent to the new scheduled resource. If a patient is shifted to a different location upon detecting an emergency, from the change in patient location, the management system interprets a change in the ADT process and the workflow is updated accordingly. Thus updated ADT information is available with the scheduled resource in advance. This is helpful if the patient has to be shifted to different location while he is in the hospital. The ADT or patient demographic information may be kept with the resource for some time and then may be deleted.

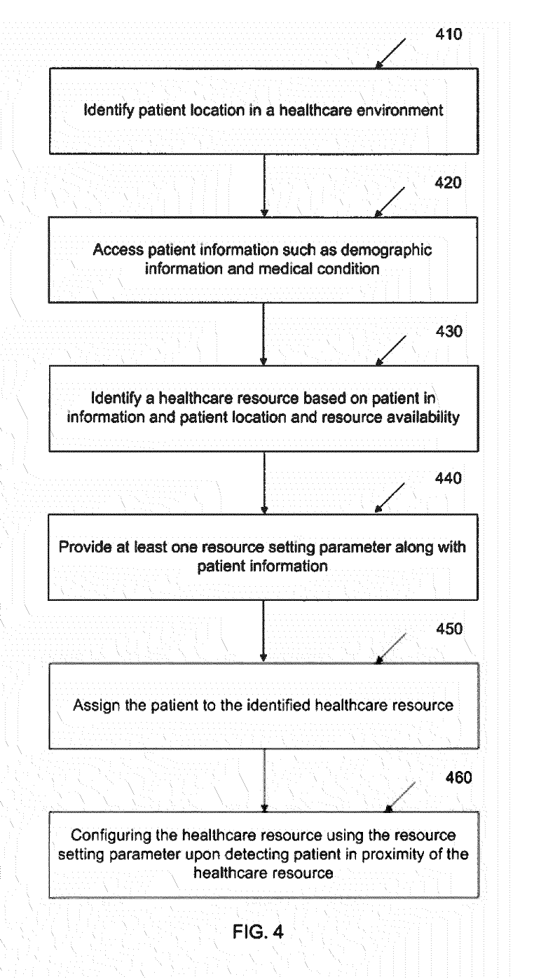

FIG. 4 is a flowchart illustrating a patient and healthcare resource management method as described in an embodiment of the invention. At step 410, patient location in a healthcare environment is identified. The patient may be provided with identifier such as RFIDs, smart chips etc and upon entering into the healthcare environment the presence of the patients is detected. The identifiers help in tracking the location of the patient as well. At step 420, patient information is accessed. The patient identification information may be sent to a server and the server may access patient information such as his demographic information or previous clinical history from a database or EMR (Electronic Medical Record) or EHR (Electronic Health Record). The patient's current medical condition could also be accessed. At step 430, a healthcare resource is identified using the patient information, patient location, current medical condition, resource availability etc. At step 440, at least one resource setting parameter is derived based on the patient information. The resource setting parameters could be patient specific and this information along with the patient information is given to the identified healthcare resource. At step 450, the patient is assigned to the identified healthcare resource. The patient may be provided with the healthcare resource information such as navigation information or reporting time etc. At step 460, patient's proximity to the healthcare resource is identified and the healthcare resource is configured using the resource setting parameter upon identifying the patient near to the healthcare resource. It is also possible to access some frequently accessed patient information to the healthcare resource or display the same on the healthcare resource upon identifying the patient in proximity of the healthcare resource.

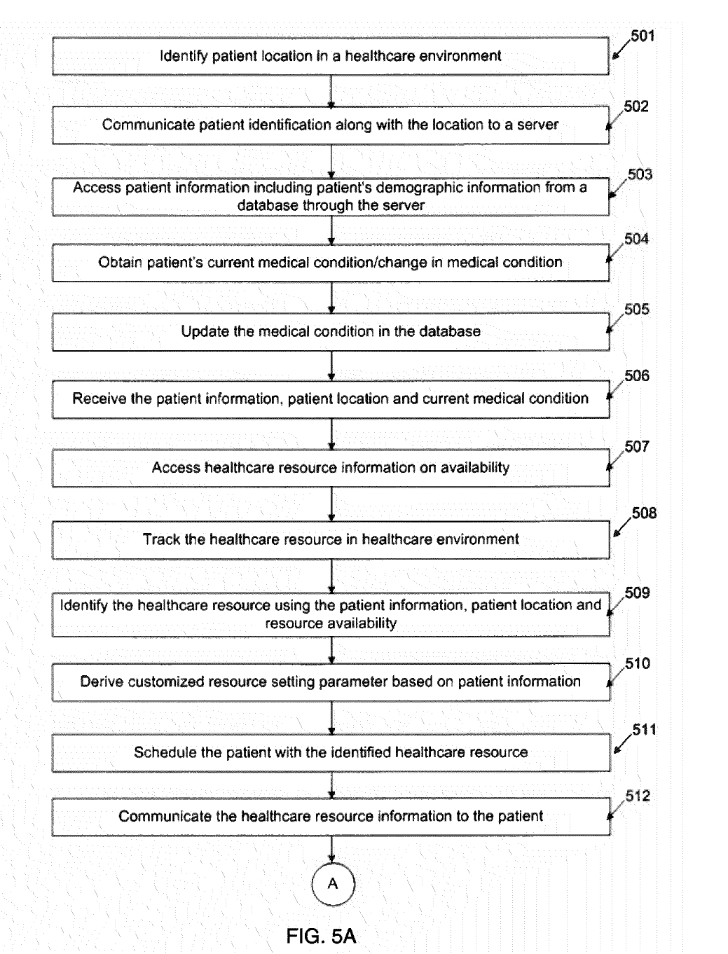

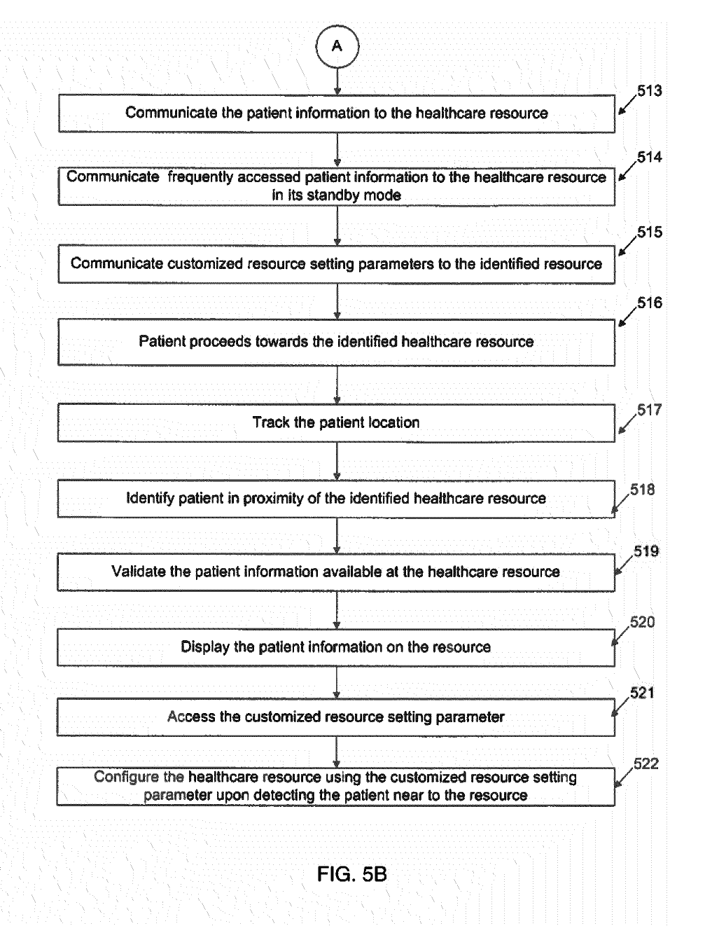

FIG. 5 is a detailed flowchart illustrating a patient and healthcare resource management method as described in an embodiment of the invention. At step 501, patient location in a healthcare environment is identified. The patient may be provided with identifier such as RFIDs (Radio frequency Identifiers), smart chips etc and upon entering into the healthcare environment the presence of the patients is detected. The identifiers help in tracking the location of the patient as well. At step 502, the patient identification such as patient's identification number along with his location is communicated to a server. The server could be an external or internal server to the healthcare environment. At step 503, the server accesses a database using the patient identification and additional patient information is accessed. The server may access his demographic information and/or his previous history. At step 504, patient's current medical condition is accessed.

This could be obtained from the caretaker, or the patient directly. If there are any changes in the medical condition, that could be communicated to the database through the server. At step 505, the database is updated with patient's current medical condition. At step 506, to a patient management system, patient information, patient's location, current medical condition etc has been accessed. This helps the patient management system in scheduling the patient more efficiently. At step 507, the resource availability information is also accessed. In step 508, the healthcare resources are tracked. Each of the healthcare resource is provided with a tracking device and their locations have been tracked. Some of the resources might be stationary and others could be dynamic. During step 509, a healthcare resource is identified based on the patient information, his location, and the availability and other aspects of the resource. Considering different parameters, most desired healthcare resource is identified. At step 510, at least one customized resource setting parameters are identified. For example, if the patient is an infant, patient monitoring parameters should be adjusted accordingly. Some of the parameters such as X-ray exposure for imaging, cuff size for Blood pressure measurement etc need to be adjusted for an infant patient. At step 511, patient is scheduled with the identified resource. The healthcare resource information is being communicated to the patient as shown at step 512. The information could include navigation information to the healthcare resource. This may be communicated directly to the patient or to a registration unit or to a caretaker. Steps 513-515 show that different information being communicated to the scheduled healthcare resource. All this information is being communicated to the device while the resource is in standby mode. Patient information such as his identification or schedule information is communicated to the resource at step 513. Apart from the patient information, certain frequently accessed information could be sent to the resource. This information could include patient's demographic information, any other information specific to the patient such allergic medicine, dietary restrictions etc. Also Admission Discharge Transfer information could be sent to the healthcare resource, as at step 514. The customized resource setting parameter could also be communicated to the resource, as shown at step 515, Once patient receives the resource information, the patient proceeds towards the resource, as at step 516 and the patient location is being tracked at step 517. This helps in navigating patient accurately and keeping track of any change that he or the caretaker could have made. At step 518, the healthcare resource is informed about the presence of the patient when the patient reaches in proximity of the resource. The healthcare resources have the patient information and this information is validated. A graphic interface may ask the clinician to confirm the display of the patient information. Upon receiving the confirmation, the patient information may be displayed on the resource or may be provided to the clinician in any other form as shown at steps 519 and 520. Further, the customized resource setting parameter are accessed, at step 521 and the resource is customized based on the patient need using the customized resource setting parameter, as at step 522.

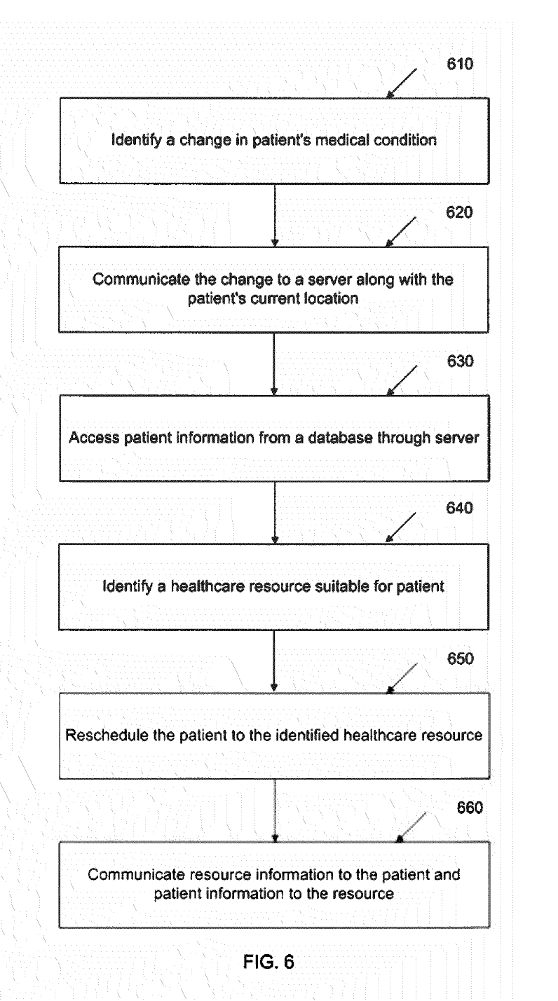

FIG. 6 is a flowchart illustrating a method of re-scheduling patients in a healthcare environment as described in an embodiment of the invention. At step 610, a change in patients medical condition is identified. The patient may enter into the hospital or scheduled for a treatment based on certain facts such as symptoms shown by the patient, his previous history etc. However the clinical condition of the patient may change and that change has to be identified and patient needs to be rescheduled based on the changed medical condition. At step 620, the changes are communicated to a server along with the patient location. This could be done by the patient himself or by the caretaker or registration unit based on the situation. Patient may report the changes at the registration desk and this information may be communicated in real time to the server/data repository and to the scheduled healthcare device, if any. At step 630, patient information from the database is accessed through the server. The patient's current schedule is analyzed based on the changes medical condition. The patient information could include other information relating to patient as well. At step 640, a desired healthcare resource is identified based on the patient's updated medical condition, his location and the resource availability. If the patient's condition is serious, then he needs to be admitted to the Intensive Care Unit (ICU). The nearest ICU location and availability of beds will be checked and patient will be scheduled for the ICU. Thus patient is re scheduled for a new healthcare resource, as at step 650. Some time the patient may still use the earlier scheduled healthcare resource, but he may get priority or the timings of the appointment may be changed. At step 660, the resource information is communicated to the patient or to the caretaker. The location of the resource schedule may be communicated to the patient directly, if the tracking device provided to him is associated with display or may be communicated to the patient through a caretaker. Similarly the patient information may be communicated to the resource as well. When the patient approaches the resource this information may be displayed on the resource or the resource may be customized based on the patient need.

In yet other embodiments of the present invention, a machine readable medium or media may include, but not limited to, magnetic disks and diskettes, optical disks and diskettes, and/or ROM, flash ROM, and/or battery backed RAM, or any other suitable magnetic, optical, or electronic medium or media. The medium (or media) has recorded thereon instructions configured to instruct a system that includes a computer, memory, and a display. The instructions include instructions for accessing patient information including demographic information and patient's current medical condition; instructions for identifying a healthcare resource using the patient information, patient location and resource availability and instructions for displaying and/or configuring the identified healthcare resource based on the patient information, even before the patient reaches the resource.

However software and/or firmware (hereinafter referred to generically as “software”) can be used to instruct the computer to perform the inventive combination of actions described herein. Further, in some embodiments, this may comprise one or more electronic hardware components or special-purpose hardware components that may be configured to perform the same purpose as a software module or to aid in the performance of the software module.

Some of the advantages of the invention include providing a unique way to identify, track and assign patients automatically as they enter the healthcare environment based on set of business and clinical rules such that the patient demographic information is ready when and where it is needed without any manual intervention. Patient information such as a patient's identification, location and health history is auto synchronized with various healthcare resource information. The invention also involves the concept of scheduled admits on the patient monitors, where the ADT information can be sent to the monitors in an inactive state such that the Nurse/Clinician can access it when needed.

Further, through identification of patient entry into hospitals, location and auto synchronization of patient information between patient history and monitoring device, the efficiency gains to the clinical workflow are enhanced. Also this information can be further used to report the current resource utilization such as patients scheduled per monitor at any given time such that the authorized clinicians can intervene and make necessary changes to the workflow.

Additionally, ability to track a patient from entry to exit is a powerful clinical information that would help the hospitals to generate better reports on which locations/devices/resources in the hospital are more utilized on a patient by patient as well as medical condition basis such that they can improve and plan their configurations.

The above-description of the embodiments of the methods and systems has the technical effect automatically synchronizing patient information with the healthcare resource information. Integration of clinical information of a patient with demographic information of the patient is also discussed.

As used herein, an element or step recited in the singular and proceeded with the word “a” or “an” should be understood as not excluding plural elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. Moreover, the terms “computer” and “processor” are used interchangeably herein to refer to either specialized hardware to perform digital signal processing, control, data manipulation, and/or calculations, or a general purpose computer that can be programmed to perform the same functions and/or adapted to interface with external digital signals. The phrases “computer or processor” and “processor or computer” are therefore intended to have equal scope with either of the individual terms and are not intended to imply a dichotomy between the two terms.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

We claim:

1. A computer aided method for managing patients and healthcare resources in a healthcare environment comprises:
identifying patient location in a healthcare environment;
accessing patient information including demographic information and patient's current medical condition;
identifying a healthcare resource using the patient information, patient location and resource availability;
providing at least one customized resource setting parameter derived based on patient information, along with the patient information to the identified healthcare resource;
assigning the patient to the identified healthcare resource; and
configuring the healthcare resource using the resource setting parameter, upon detecting the patient in proximity of the healthcare resource.

2. Method as claimed in claim 1, wherein the step of identifying patient location includes: identifying the patient in a healthcare environment using triangulation techniques, proximity sensors and smart readers.

3. Method as claimed in claim 1, wherein the step of accessing patient information includes:
accessing patient demographic information and patient clinical history from a database;
obtaining patient's current medical condition from the patient or caretaker; and
updating the current medical condition in the database.

4. Method as claimed in claim 3, wherein the step of obtaining patient's current medical condition further comprises: identifying any change in the patient's medical condition while the patient is in the healthcare environment.

5. Method as claimed in claim 1, wherein the step of identifying a healthcare resource comprises:
receiving the patient information and patient location;
accessing information about the available healthcare resources in the healthcare environment;
tracking the healthcare resource in the healthcare environment; and
identifying a healthcare resource based on availability of healthcare resource, patient information and patient location.

6. Method as claimed in claim 1, wherein the step of providing resource setting parameter includes:
customizing resource setting parameters based on the patient information; and
communicating the customized resource setting parameters to the identified healthcare resource while the resource is in standby mode.

7. Method as claimed in claim 1, wherein the step of assigning comprises:
scheduling the patient with the identified healthcare resource; and
indicating the healthcare resource location to the patient and patient information to the healthcare resource.

8. Method as claimed in claim 1, wherein the step of configuring healthcare resource comprises:
displaying customized resource setting parameter upon detecting the patient in proximity of the healthcare resource; and
configuring the healthcare resource using the customized resource setting parameter.

9. Method as claimed in claim 1, wherein the method further comprises:
providing frequently accessed information about the patient to a scheduled healthcare resource in a standby mode; and
displaying the information when the patient is in proximity to the resource.

10. Method as claimed in claim 9, wherein the method further comprises: displaying an Admit Discharge Transfer process, when the patient is proximity of the resource.

11. Method as claimed in claim 1, wherein the demographic information includes; name, patient identification number, age, sex, race, height, weight, and physician identification number.

12. A computer aided method for managing patients and healthcare resources in a healthcare environment comprises:
identifying a change in a patient's medical condition;
communicating the change to a server along with the patient's location information;
accessing patient information from a database through the server;
identifying a healthcare resource based on the updated medical condition, patient information and patient location;
re-scheduling the patient for the identified healthcare resource; and
communicating resource information to the patient and the patient information to the healthcare resource.

13. Method as claimed in claim 12, wherein the method further comprises: providing at least one resource setting parameter derived based on patient information, along with the patient information to the identified healthcare resource.

14. Method as claimed in claim 13, wherein the method further comprises: configuring the identified healthcare resource based on the resource setting parameter, when the patient is in proximity of the healthcare resource.

15. Method as claimed in claim 12, wherein the method further comprises: displaying frequently accessed information about the patient to the identified healthcare resource in a standby mode, when the patient is in proximity of the resource.

16. A system for managing patients and healthcare resources in a healthcare environment comprises:
a data repository for storing patient information including demographic information and patient's current medical condition and healthcare resource information in the healthcare environment;
plurality of tracking devices for identifying patient location and healthcare resource location in a healthcare environment and communicating the location information to the data repository;
a data access program module configured to access patient information and the healthcare resource information from the data repository; and
a processor operatively connected to the data access program module to identify and configure a healthcare resource based on the patient information and patient location and resource availability.

17. The system as claimed in claim 16, wherein the data access program module operates with the processor to generate a schedule for the patient and communicate the schedule to the patent and to the healthcare resource.

18. The system as claimed in claim 16, wherein the processor is configured to customize the resource setting parameter based on the patient information and configure the healthcare resource based on the customized resource setting parameter, when the patient is in proximity of the resource.

19. The system as claimed in claim 18, wherein the processor is further configured to provide frequently accessed information about the patient to the identified healthcare resource in a standby mode, when the patient is in close proximity of the resource.

20. The system as claimed in claim 19, the processor is further configured to auto synchronize patient information between the healthcare resource and the patient.
